(19) United States
(12) Patent Application Publication
(10) Pub. No.: US 2023/0001815 A1
(43) Pub. Date: Jan. 5, 2023

(54) DRAIN-ASSISTED SUPPLY GENERATION CIRCUITS

(71) Applicant: Texas Instruments Incorporated, Dallas, TX (US)

(72) Inventors: Orlando Lazaro, Cary, NC (US); Timothy Bryan Merkin, Princeton, TX (US); Yogesh Kumar Ramadass, San Jose, CA (US)

(21) Appl. No.: 17/364,652

(22) Filed: Jun. 30, 2021

(51) Int. Cl. B60L 53/60; H02M 3/155; H02M 1/08; B60L 58/10

(52) U.S. Cl. CPC B60L 53/60; H02M 3/155; H02M 1/08; B60L 58/10

(57) ABSTRACT

An example apparatus includes: a gate driver with a control output terminal, a power transistor with a gate terminal and a first current terminal, the gate terminal coupled to the control output terminal, and drain-derived supply circuitry with an output coupled to the first current terminal.

### TECHNICAL FIELD

This description relates generally to circuits, and more particularly to drain-assisted supply generation circuits.

### BACKGROUND

High-voltage and/or high-current applications require power electronic devices capable of efficient and effective operation at various operating conditions. In some such applications, power modules deliver power using power devices such as, metal-oxide-semiconductor field-effect transistors (MOSFETs), insulated-gate bipolar transistors (IGBTs), etc. A driver may be used to control a power device used as a power delivering device to support delivering power to a load.

### SUMMARY

For drain-assisted supply generation circuits, an example apparatus includes: a gate driver with a control output terminal, a power transistor with a gate terminal and a first current terminal, the gate terminal coupled to the control output terminal, and drain-derived supply circuitry with an output coupled to the first current terminal.

### BRIEF DESCRIPTION OF THE DRAWINGS

FIG. 1 is a schematic diagram of example isolated switch circuitry part of an example battery electric vehicle system.

FIG. 2 is a schematic diagram of an example implementation of the isolated switch circuitry of FIG. 1.

FIG. 3 is a schematic diagram of another example implementation of the isolated switch circuitry of FIG. 1.

FIG. 4 is a schematic diagram of yet another example implementation of the isolated switch circuitry of FIG. 1.

FIG. 5 is a schematic diagram of another example implementation of the isolated switch circuitry of FIG. 1.

FIG. 6 depicts an example timing diagram corresponding to example operation of the isolated switch circuitry of FIGS. 1, 2, and/or 3.

FIG. 7 depicts an example timing diagram corresponding to example operation of the isolated switch circuitry of FIGS. 1 and/or 4.

FIG. 8 depicts an example timing diagram corresponding to example operation of the isolated switch circuitry of FIG. 5.

FIG. 9 is a flowchart representative of an example process that may be performed using machine readable instructions that can be executed and/or hardware configured to implement the example isolated switch circuitry of FIGS. 1, 2, and/or 3 to achieve isolated gate control.

FIG. 10 is another flowchart representative of an example process that may be performed using machine readable instructions that can be executed and/or hardware configured to implement the example isolated switch circuitry of FIGS. 1 and/or 4 to achieve isolated gate control.

### DETAILED DESCRIPTION

The drawings are not necessarily to scale. Generally, the same reference numbers in the drawing(s) and this description refer to the same or like parts. Although the drawings show layers and regions with clean lines and boundaries, some or all of these lines and/or boundaries may be idealized. In reality, the boundaries and/or lines may be unobservable, blended and/or irregular.

High-voltage and/or high-current applications may utilize power electronic devices capable of efficient and effective operation at various operating conditions. In some such applications, power circuitry may deliver power to a load using power devices, which may be implemented utilizing transistors. Some such transistors (such as power transistors) may include field-effect transistors (FETs), metal-oxide-semiconductor field-effect transistors (MOSFETs), insulated-gate bipolar transistors (IGBTs), etc. A driver may be used to control a power device (such as a transistor) to achieve power delivery to a load.

Some power circuitry may include a capacitively powered and isolated driver, a transistor, and isolation capacitors. In some such power circuitry, self-induced common-mode transients may cause power interruptions of the capacitively powered and isolated driver. The power interruptions may cause improper control of the transistor. For example, when the transistor is turned off, a transmit ground and a receive ground of the power circuitry may be approximately equipotential. In some such examples, when the transistor is turned on, the receive ground may rise relative to the transmit ground. The isolation capacitors may charge with common-mode current to support the ground difference. If the common-mode current is greater than the differential-mode current, then a current drought may occur. The current drought may cause an inadequate quantity of current to be provided to the driver when the transistor is to be turned on. The driver may not be enabled when needed if the quantity of current is inadequate and, if not enabled, the driver may not turn on the transistor at a time when the transistor is to be turned on. If the driver is not enabled when needed, then the driver may achieve improper control of the transistor.

Examples described herein include example drain-derived supply circuitry as part of example isolation switch circuitry. The drain-derived supply circuitry may achieve drive control of a transistor (such as a driven transistor), which may be part of the isolation switch circuitry, during a self-induced common-mode transient. In some described examples, the drain-derived supply circuitry may cause charge (such as auxiliary charge) to be drawn from a drain of the driven transistor. The drawn charge may be provided to a power terminal of a driver, which may be part of the isolation switch circuitry. Advantageously, the drain-derived supply circuitry described herein may provide the charge to the driver to ensure that the driver has sufficient voltage to turn on (or off) the driven transistor. Advantageously, in response to the provided charge, the driver may achieve proper drive control of the driven transistor.

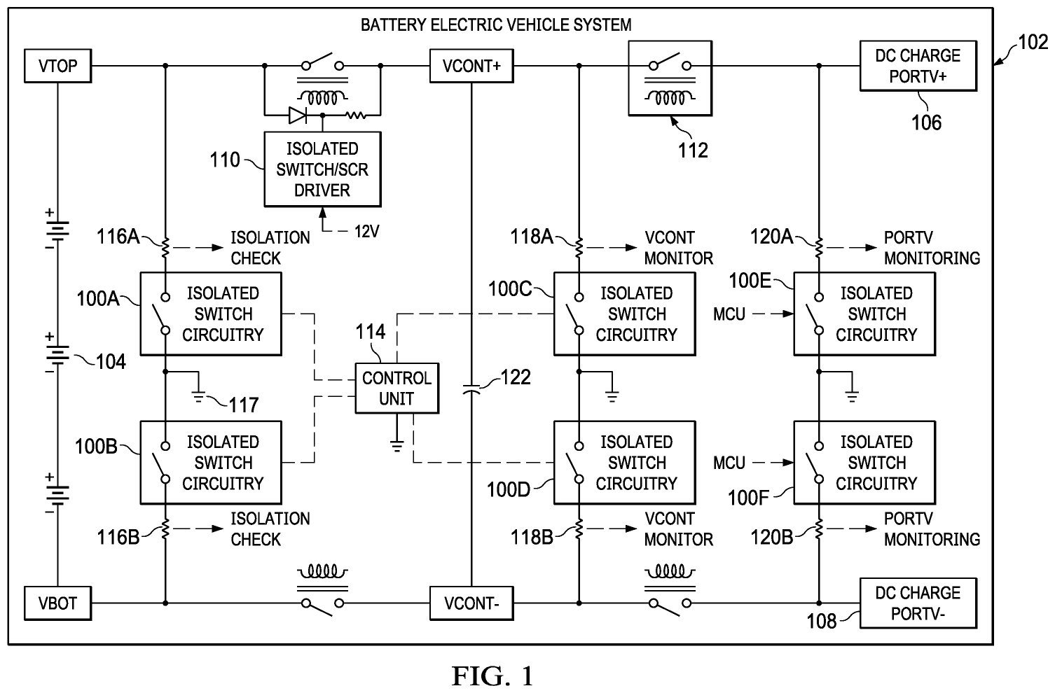

FIG. 1 is a schematic diagram of example isolated switch circuitry 100A-100F that are part of an example battery electric vehicle system 102. First example isolated switch circuitry 100A, second example isolated switch circuitry 100B, third example isolated switch circuitry 100C, fourth example isolated switch circuitry 100D, fifth example isolated switch circuitry 100E, and sixth example isolated switch circuitry 100F are part of the battery electric vehicle system 102. For example, one(s) of the isolated switch circuitry 100A-100F may implement high-voltage isolated switches (such as isolated switches having an operating voltage rating of 1200 Volts (V), 1400 V, etc.). In this example, the battery electric vehicle system 102 is battery charging circuitry part of a vehicle (such as an electric vehicle, a hybrid-electric vehicle, an aircraft, an unmanned aerial vehicle, etc.). Example power sources 104 part of the battery electric vehicle system 102 may provide power to a powertrain of the vehicle. In this example, the power sources 104 may be implemented by batteries (such as lithium-ion batteries). For example, the batteries may be adapted to output power to the vehicle. In some examples, the battery electric vehicle system 102 may achieve charging of the power sources 104 using power derived from an alternating current (AC) power source. Example charge ports 106, 108 including an example positive polarity charge port 106 and an example negative polarity charge port 108 are part of the battery electric vehicle system 102. For example, the charge ports 106, 108 may be coupled to power conversion circuitry, which may convert AC power from the AC power source to direct current (DC) power. In some such examples, the charge ports 106, 108 may receive the DC power and provide the DC power to the battery electric vehicle system 102. In some such examples, the positive polarity charge port 106 is a battery charging terminal and the negative polarity charge port 108 is a battery charging terminal.

Example isolated switch and silicon controlled rectifier (SCR) drive circuitry 110, example relay circuitry 112, and an example control unit 114 are part of the battery electric vehicle system 102. In some examples, the isolated switch and SCR drive circuitry 110 may implement driver circuitry (such as isolated driver circuitry). In some examples, the relay circuitry 112 may implement a switch. For example, the relay circuitry 112 may implement an electromechanical switching device including a coil to be used to generate a magnetic force that mechanically operates an electric contact. The relay circuitry 112, when enabled, achieves delivery of power from the charge ports 106, 108 to the power sources 104. The relay circuitry 112, when disabled, interrupts delivery of the power from the charge ports 106, 108 to the power sources 104. The isolated switch and SCR drive circuitry 110 may control when power is provided or interrupted.

In some examples, the control unit 114 may be implemented by a micro control unit, a motor control unit (MCU), etc., to control operation of a power train (such as an electric motor) of the vehicle. In some such examples, the control unit 114 may be implemented by a controller, a hardware logic, machine readable instructions, hardware implemented state machines, and/or any combination thereof. In this example, the control unit 114 may control operation of the isolated switch circuitry 100A-100F. For example, the control unit 114 may invoke one(s) of the isolated switch circuitry 100A-100F to turn on or off. In some examples, the control unit 114 may determine isolation of the power sources 104 based on first measurements (ISOLATION CHECK) from first example sensors 116A-116B. For example, the isolation check may indicate whether the positive or negative terminal of a battery are soft-shorted to an example chassis 117 of the vehicle, which is represented by a ground reference potential. The control unit 114 may measure a first voltage VCONT+ and a second voltage VCONT− based on second measurements (VCONT MONITOR) from second example sensors 118A-118B. For example, the second measurements may indicate whether the isolated switch and SCR drive circuitry 110 is enabled or disabled. The control unit 114 may measure a third voltage at the positive polarity charge port 106 and a fourth voltage at the negative polarity charge port 108 based on third measurements (PORTV MONITORING) from third example sensors 120A-120B. For example, the third measurements may indicate whether the relay circuitry 112 is enabled or disabled. One(s) of the first sensors 116A-116B, the second sensors 118A-118B, and/or the third sensors 120A-120B may be implemented with a current sensor (such as a current transformer), a voltage sensor (such as a resistive-type sensor, a capacitor-type sensor, etc.), etc.

In the illustrated example of FIG. 1, the power sources 104 are coupled to the first isolated switch circuitry 100A and the isolated switch and SCR drive circuitry 110. The isolated switch and SCR drive circuitry 110 are coupled to an example capacitor 122 and one of the relay circuitry 112. The one of the relay circuitry 112 is coupled to the fifth isolated switch circuitry 100E and the positive polarity charge port 106. The first isolated switch circuitry 100A is coupled to the second isolated switch circuitry 100B. The third isolated switch circuitry 100C is coupled to the fourth isolated switch circuitry 100D. The fifth isolated switch circuitry 100E is coupled to the sixth isolated switch circuitry 100F. Output(s) (e.g., control unit output(s)) of the control unit 114 is/are coupled to input(s) (e.g., control input(s)) of the isolated switch circuitry 100A-100F.

In example operation, the control unit 114 may receive the first measurements, the second measurements, and/or the third measurements. The control unit 114 may determine to turn on one(s) of the isolated switch and SCR drive circuitry 110 and the relay circuitry 112 to achieve power delivery from the charge ports 106, 108 to the power sources 104. The control unit 114 may determine to turn on one(s) of the isolated switch circuitry 100A-100F to implement the isolation check, VCONT monitor, and/or PORTV monitoring functions. For example, the control unit 114 may turn on the first isolated switch circuitry 100A and the second isolated switch circuitry 100B to determine whether the positive and negative terminals of the power sources 104 are isolated from the chassis 117 of the vehicle. In some such examples, the control unit 114 may turn on the third isolated switch circuitry 100C and the fourth isolated switch circuitry 100D to determine whether the isolated switch and SCR drive circuitry 110 is enabled or disabled. In some such examples, the control unit 114 may turn on the fifth isolated switch circuitry 100E and the sixth isolated switch circuitry 100F to determine whether the relay circuitry 112 is enabled or disabled. Advantageously, the isolated switch circuitry 100A-100F described herein improve safety in connection with operating the vehicle.

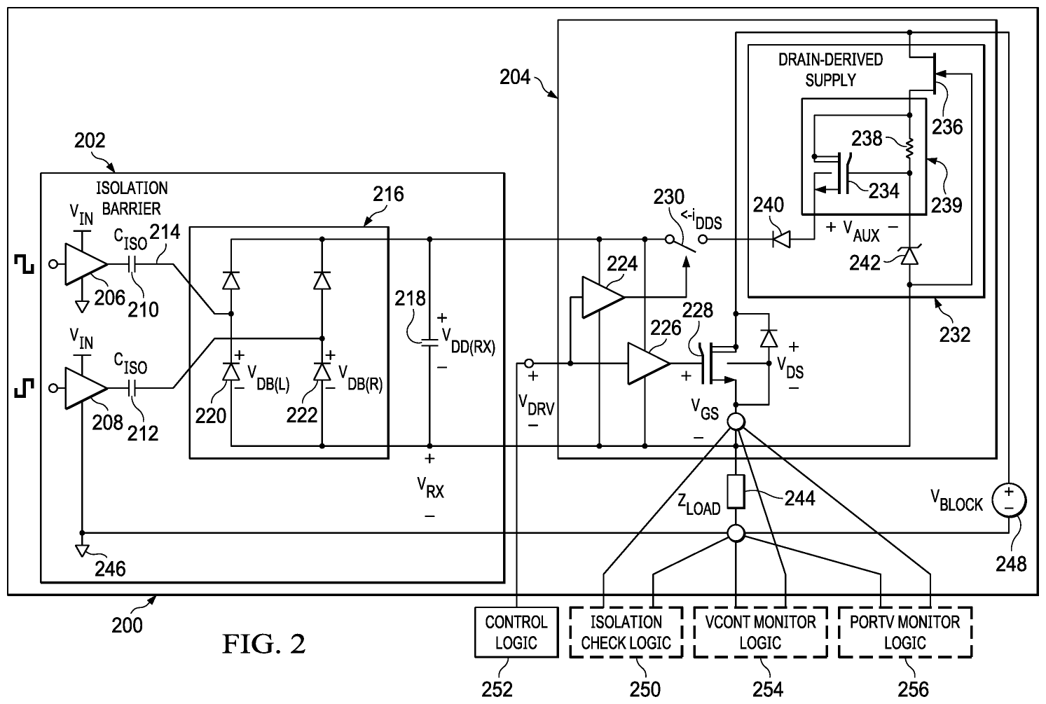

FIG. 2 is a schematic diagram of example isolated switch circuitry 200. The isolated switch circuitry 200 of FIG. 2 may be an example implementation of the isolated switch circuitry 100A-100F of FIG. 1. First example circuitry 202 and second example circuitry 204 are part of the isolated switch circuitry 200. In some examples, the first circuitry 202 may implement a power converter (such as a switched capacitor power converter), a charge pump, etc. In some examples, the second circuitry 204 may implement a driver (such as a floating driver).

In some examples, the isolation switch circuitry 200 is a single integrated circuit (IC) (such as a single IC package). For example, the first circuitry 202 and the second circuitry 204 may be included on the same die. In some examples, the isolation switch circuitry 200 may be implemented by two or more ICs in a single IC package to implement a multi-chip module (MCM). In some examples, the isolation switch circuitry 200 may be implemented by two or more ICs (such as two or more IC packages). For example, the first circuitry 202 may be on a first die and the second circuitry 204 may be on a second die. In some examples, the first circuitry 202 may be on a first die, the drain-derived supply circuitry 232 may be on a second die, and the third driver 224, the fourth driver 226, and the first transistor 228 may be on a third die. Alternatively, one or more hardware circuit components (such as the first driver 206, the second driver 208, the first capacitor 210, the second capacitor 212, the diode bridge 216, etc.) of the first circuitry 202 may be included in the second circuitry 204. Alternatively, one or more hardware circuit components (such as the third driver 224, the fourth driver 226, the first transistor 228, the switch 230, the drain-derived supply circuitry 232, etc.) of the second circuitry 204 may be included in the first circuitry 202. Alternatively, one or more hardware circuit components (such as the third diode 240, the second transistor 234, the resistor 238, etc.) of the drain-derived supply circuitry 232 may be included in the first circuitry 202.

A first example driver 206, a second example driver 208, a first example capacitor 210 and a second example capacitor 212 as part of an example isolation barrier 214, an example diode bridge 216, and a third example capacitor 218 are part of the first circuitry 202. In some examples, the first driver 206 and/or the second driver 208 may be implemented by a digital buffer that is configured to receive a signal input (such as a square wave input). For example, the digital buffer may implement the first driver 206 to provide a low output resistance to drive the first capacitor 210. Alternatively, the first driver 206 and/or the second driver 208 may be replaced with and/or otherwise implemented with a power oscillator (such as a power inverter) to drive (such as directly drive) the first capacitor 210 and/or the second capacitor 212. For example, the power oscillator may output a sinusoidal signal to drive the first capacitor 210 and/or the second capacitor 212.

An input of the first driver 206 is coupled to a first terminal of the first circuitry 202. An output of the first driver 206 is coupled to a first terminal (such as a first capacitor terminal) of the first capacitor 210. A second terminal (such as a second capacitor terminal) of the first capacitor 210 is coupled to an input of the diode bridge 216. An input (such as a control input terminal) of the second driver 208 is coupled to a second terminal of the first circuitry 202. An output of (such as a control output terminal) the second driver 208 is coupled to a first terminal of the second capacitor 212. A second terminal of the second capacitor 212 is coupled to an input of the diode bridge 216. Output(s) of the diode bridge 216 coupled to a first terminal of the third capacitor 218 and input(s) of the second circuitry 204. An input voltage V_{IN} may be provided to power inputs of the drivers 206, 208. The capacitors 210, 212 have a capacitance of C_{ISO}. The third capacitor 218 has a voltage V_{DD(RX)}. A first example diode 220 and a second example diode 222 are part of the diode bridge 216. The first diode 220 has a voltage V_{DB(L)} and the second diode 222 has a voltage V_{DB(R)}.

A third example driver 224, a fourth example driver 226, a first example transistor 228, an example switch 230, and example drain-derived supply circuitry 232 are part of the second circuitry 204. A second example transistor 234, a third example transistor 236, an example resistor 238, a third example diode 240, and a fourth example diode 242 are part of the drain-derived supply circuitry 232. The first transistor 228 is an N-channel metal-oxide-semiconductor field-effect transistor (MOSFET). For example, the first transistor 228 may be a power transistor. Alternatively, the first transistor 228 may be an N-channel field-effect transistor (FET), an N-channel insulated-gate bipolar transistor (IGBT), an N-channel junction field effect transistor (JFET), or an NPN bipolar junction transistor (BJT). The switch 230 is a transistor. For example, the switch 230 may be implemented by a MOSFET, a FET, an IGBT, a JFET, a BJT, etc.

The second transistor 234 is an N-channel MOSFET. Alternatively, the second transistor 234 may be an N-channel FET, an N-channel IGBT, an N-channel JFET, or an NPN BJT. The third transistor 236 is an N-channel JFET. Alternatively, the third transistor 236 may be an N-channel FET, an N-channel IGBT, an N-channel MOSFET, or an NPN BJT. The fourth diode 242 is a Zener diode. Alternatively, the fourth diode 242 may be any other type of diode or replaced with a voltage reference. In this example, the second transistor 234 and the fourth diode 242 may implement an open-loop linear voltage regulator. Alternatively, the open-loop linear voltage regulator may be implemented in a number of ways. In this example, the drain-derived supply circuitry 232 is implemented using a JFET (such as the third transistor 236) and a Zener-Source-Follower circuit (such as the resistor 238 and the second transistor 234). For example, the resistor 238 and the second transistor 234 may be part of example source-follower circuitry 239. Alternatively, any other combination of logic circuits or hardware circuit elements may be utilized to implement the drain-derived supply circuitry 232 to provide auxiliary charge to the first transistor 228.

An example load impedance (Z_{LOAD}) 244 is depicted in FIG. 2 at a source (such as a current terminal, a source terminal, etc.) of the first transistor 228 with respect to an example reference voltage terminal 246. An example blocking voltage V_{BLOCK} 248 is depicted in FIG. 2 at a drain (such as a current terminal, a drain terminal, etc.) of the first transistor 228 with respect to the reference voltage terminal 246. The blocking voltage 248 may correspond to the maximum voltage that can be applied to the first transistor 228. The blocking voltage 248 may correspond to a maximum voltage that may be tolerated by the first transistor 228 when not conducting to avoid damage of the first transistor 228. A drive voltage V_{DRV} may be provided to the inputs (such as control input terminals) of the third driver 224 and the fourth driver 226. For example, the drive voltage may be generated by the control unit 114 of FIG. 1. A gate-to-source voltage V_{GS} is across a gate (such as a gate terminal) and the source of the first transistor 228. A drain-to-source voltage V_{DS} is across the drain and the source of the first transistor 228. An auxiliary voltage V_{AUX} is at an anode of the third diode 240 with respect to the source of the first transistor 228. For example, the auxiliary voltage may be defined relative to the receiver (RX) ground.

A power input (such as a power input terminal) of the third driver 224 is coupled to output(s) of the diode bridge 216, the first terminal of the third capacitor 218, and a first terminal (such as a first switch terminal) of the switch 230. An output of the third driver 224 is coupled to a control terminal (such as a switch control terminal) of the switch 230. A reference voltage terminal (such as a ground terminal) of the third driver 224 is coupled to the diode bridge 216, the source of the first transistor 228, an anode (such as an anode terminal, a diode terminal, etc.) of the fourth diode 242, a gate of the third transistor 236, and/or, more generally, the drain-derived supply circuitry 232.

A power input of the fourth driver 226 is coupled to output(s) of the diode bridge 216, the first terminal of the third capacitor 218, and the first terminal of the switch 230. An output (such as a control output terminal) of the fourth driver 226 is coupled to a gate of the first transistor 228. A reference voltage terminal (such as a ground terminal) of the fourth driver 226 is coupled to the diode bridge 216, the source of the first transistor 228, the anode of the fourth diode 242, the gate of the third transistor 236, and/or, more generally, the drain-derived supply circuitry 232.

A second terminal of the switch 230 is coupled to a cathode (such as a cathode terminal, a diode terminal, etc.) of the third diode 240, and/or, more generally, to the drain-derived supply circuitry 232. The drain of the first transistor 228 is coupled to the drain of the third transistor 236, and/or, more generally, the drain-derived supply circuitry 232. An anode of the third diode 240 is coupled to the source of the second transistor 234. A cathode of the fourth diode 242 is coupled to a gate of the second transistor 234 and a first terminal (e.g., a first resistor terminal) of the resistor 238. A drain of the second transistor 234 is coupled to a second terminal (e.g., a second resistor terminal) of the resistor 238 and a source of the third transistor 236.

One(s) of example isolation check logic 250, example control logic 252, example VCONT monitor logic 254, and/or example PORTV monitor logic 256 are adapted to be coupled to the isolation switch circuitry 200. For example, the control logic 252 and one of the isolation check logic 250, the VCONT monitor logic 254, or the PORTV monitor logic may be coupled to the isolation switch circuitry 200. In some examples, one or more of the isolation check logic 250, the control logic 252, the VCONT monitor logic 254, and/or the PORTV monitor logic 256 may be coupled to the isolation switch circuitry 200.

In some examples, the isolation check logic 250 may implement one(s) of the first sensors 116A-116B. For example, the isolation check logic 250 may implement the isolation check function of FIG. 1. In some examples, the control logic 252 may implement the control unit 114 of FIG. 1. In some examples, the VCONT monitor logic 254 may implement one(s) of the second sensors 118A-118B. For example, the VCONT monitor logic 254 may implement the VCONT monitoring function of FIG. 1. In some examples, the PORTV monitor logic 256 may implement one(s) of the third sensors 120A-120B. For example, the PORTV monitor logic 256 may implement the PORTV monitoring function of FIG. 1.

The isolation check logic 250 is adapted to be coupled across the load impedance 244. For example, the isolation check logic 250 may be configured to periodically connect the positive and negative terminals of the power sources 104 of FIG. 1 to the chassis 117 of the vehicle with a current limiting resistor having a substantially large resistance. In some such examples, the isolation check logic 250 may be configured to connect the positive terminal of the power sources 104 to the chassis 117 at a first time and disconnect the negative terminal of the power sources 104 from the chassis 117 at the first time. In some such examples, the isolation check logic 250 may be configured to disconnect the positive terminal of the power sources 104 from the chassis 117 at a second time and connect the negative terminal of the power sources 104 to the chassis 117 at the second time. In some such examples, if the chassis 117 is isolated from either terminal of the power sources 104, the chassis 117 and the power sources 104 may equilibrate, which may cause DC current not to flow through the current limiting resistor implemented by the isolation check logic 250.

The control logic 252 is adapted to be coupled to the control input of the third driver 224 and the control input of the fourth driver 226. For example, the control logic 252 may be configured to turn on (or off) the third driver 224 and/or the fourth driver 226. The VCONT monitor logic 254 is adapted to be coupled across the load impedance 244 (such as the source of the first transistor 228 and the reference voltage terminal 246). For example, the VCONT monitor logic 254 may be configured to periodically connect the positive and negative terminals of the power sources 104 of FIG. 1 to the chassis 117 of the vehicle with a current limiting resistor having a substantially large resistance. In some such examples, the VCONT monitor logic 254 may be configured to connect the positive terminal of the power sources 104 to the chassis 117 at a first time and disconnect the negative terminal of the power sources 104 from the chassis 117 at the first time. In some such examples, the VCONT monitor logic 254 may be configured to disconnect the positive terminal of the power sources 104 from the chassis 117 at a second time and connect the negative terminal of the power sources 104 to the chassis 117 at the second time. In some such examples, if the chassis 117 is isolated from either terminal of the power sources 104, the chassis 117 and the power sources 104 may equilibrate, which may cause DC current not to flow through the current limiting resistor implemented by the VCONT monitor logic 254.

The isolated switch circuitry 200 achieves data and/or power transfer between a high-voltage domain and a low-voltage domain, while preventing and/or otherwise reducing DC or uncontrolled transient current flowing through the isolated switch circuitry 200. For example, the first driver 206 and the second driver 208 may be configured to receive a DC voltage (V_{IN}). In some such examples, V_{IN} may be generated by an isolated power converter that draws power from the power sources 104 of FIG. 1. The isolation barrier 214 may implement galvanic isolation to achieve a reliable reinforced isolation between the high-voltage domain and the low-voltage domain of the first circuitry 202, and/or, more generally, the isolated switch circuitry 200. Advantageously, the isolation barrier 214 may prevent unwanted DC voltage from passing through to the diode bridge 216. The diode bridge 216 may rectify the digital signal input (such as a square wave) received by the first driver 206 and the second driver 208 into DC voltage to be stored by the third capacitor 218 as V_{DD(RX)}.

In example operation, the fourth driver 226 may output a control signal to turn on the first transistor 228 to provide power to a load, which is represented by the load impedance 244. In some prior isolated switch circuitry, self-induced common-mode transients may cause power interruptions to the fourth driver 226, which, in turn, may cause improper control of the first transistor 228. For example, in response to the first transistor 228 being turned off, a transmit (TX) ground (such as a node at the source of the first transistor 228) and a receive (RX) ground (such as the reference voltage terminal 246) may be equipotential. In some such examples, the isolated switch circuitry 200 may have the blocking voltage V_{BLOCK} 248. For example, V_{RX} may be equipotential. In some such examples, in response to the first transistor 228 being turned on, the RX ground may rise relative to the TX ground. For example, V_{RX} may become positive relative to the reference voltage terminal 246. In some such examples, the first capacitor 210 and the second capacitor 212 may charge with the common-mode current to support the ground difference between the TX and RX grounds. In some such examples, if the common-mode current overwhelms the differential-mode current, then the fourth driver 226 may experience a current drought. For example, the fourth driver 226 may not have enough voltage potential at the power input of the fourth driver 226 to turn on the first transistor 228 when needed. Advantageously, the drain-derived supply circuitry 232 achieves improvements over such prior isolated switch circuitry as described herein.

In example operation, during a turn-on event (such as turning on the first transistor 228), a self-induced common mode transient event may occur to cause V_{RX} to increase (such as become positive) and V_{DS} to decrease (such as become negative). In example operation, during the turn-on event, auxiliary charge is derived from the drain-derived supply circuitry 232. For example, the drain of the third transistor 236 has the same drain voltage of the first transistor 228. In some such examples, the third driver 224 turns on the switch 230 to cause the auxiliary charge to flow from the drain-derived supply circuitry 232 to the third capacitor 218 to cause V_{DD(RX)} to increase. For example, the auxiliary charge may flow in a direction represented by i_{DDS} in FIG. 2. In some such examples, charge may flow from the drain of the first transistor 228 through the third transistor 236, the second transistor 234, the third diode 240, and the switch 230 to charge the third capacitor 218. The current i_{DDS} may charge the third capacitor 218 to provide additional charge to be supplied to the power inputs of the third driver 224 and/or the fourth driver 226. Advantageously, the drain-derived supply circuitry 232 provides charge derived and/or otherwise based on the drain voltage of the first transistor 228 to the third capacitor 218. In response to the third capacitor 218 storing the auxiliary charge, the voltage at the power input of the fourth driver 226 increases. In example operation, in response to a collapse of V_{DS}, the self-induced common-mode transient may conclude. In example operation, in response to the conclusion of the self-induced common-mode transient, the drain-derived supply voltage V_{AUX} collapses. Advantageously, the fourth driver 226 has sufficient voltage at the power input of the fourth driver 226 to turn on and maintain the first transistor 228 in the on or enabled state during a self-induced common-mode transient event thereby achieving power to continue to be delivered to the third capacitor 218.

Advantageously, the auxiliary charge provided by the drain-derived supply circuitry 232 enables the third capacitor 218 to be relatively small (such as have a relatively small capacitance). Advantageously, the operation of the drain-derived supply circuitry 232 achieves the support of a wide range of self-induced common-mode transient rates. Advantageously, the operation of the switch 230 achieves the drawing of the auxiliary charge from the drain-derived supply circuitry 232 in response to engaging and/or otherwise enabling the first transistor 228. Advantageously, in response to the first transistor 228 blocking (such as causing the blocking voltage 248 to be generated), V_{DRV} may be set low and minimal leakage current may be drawn from the drain of the first transistor 228.

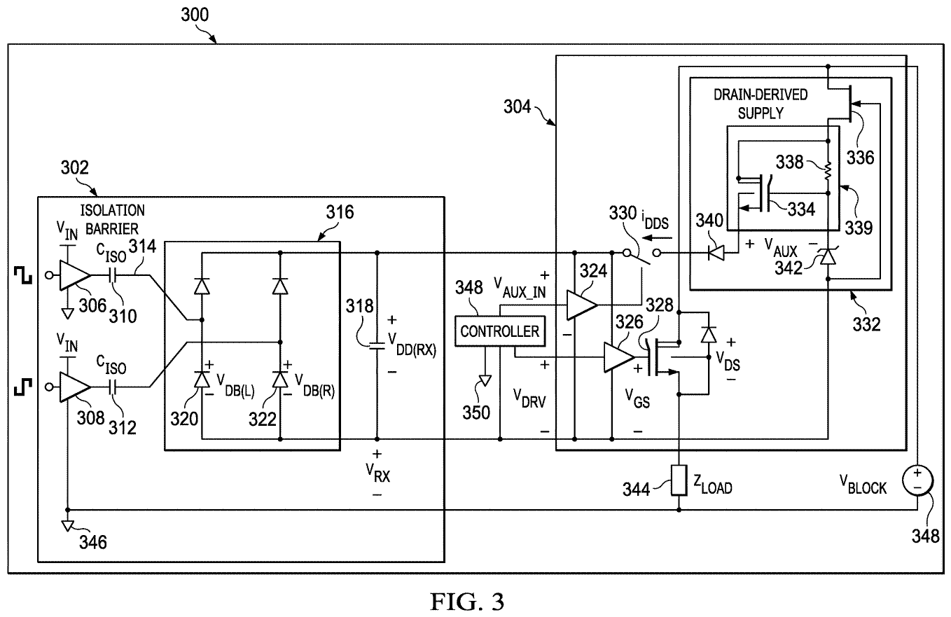

FIG. 3 is a schematic diagram of example isolated switch circuitry 300. The isolated switch circuitry 300 of FIG. 3 may be an example implementation of the isolated switch circuitry 100A-100F of FIG. 1. First example circuitry 302 and second example circuitry 304 are part of the isolated switch circuitry 300. A first example driver 306, a second example driver 308, a first example capacitor 310 and a second example capacitor 312 as part of an example isolation barrier 314, an example diode bridge 316, and a third example capacitor 318 are part of the first circuitry 302. The third capacitor 318 has a voltage V_{DD(RX)}. A first example diode 320 and a second example diode 322 are part of the diode bridge 316. The first diode 320 has a voltage V_{DB(L)} and the second diode 322 has a voltage V_{DB(R)}.

A third example driver 324, a fourth example driver 326, a first example transistor 328, an example switch 330, and example drain-derived supply circuitry 332 are part of the second circuitry 304. A first drive voltage V_{AUX_EN} may be provided to the input (such as the control input) of the third driver 324. A second drive voltage V_{DRV} may be provided to the input (such as the control input) of the fourth driver 326. A gate-to-source voltage V_{GS} is across a gate and a source of the first transistor 328. A drain-to-source voltage V_{DS} is across a drain and the source of the first transistor 328. An auxiliary voltage V_{AUX} is at an anode of the third diode 340 with respect to an example reference voltage terminal 346. A second example transistor 334, a third example transistor 336, an example resistor 338, a third example diode 340, and a fourth example diode 342 are part of the drain-derived supply circuitry 332. In this example, the resistor 338 and the second transistor 334 may be part of example source-follower circuitry 339.

In the illustrated example of FIG. 3, one or more of the hardware circuit elements may correspond to one or more of the hardware circuit elements of FIG. 2. For example, the first driver 306 of FIG. 3 may correspond to the first driver 206 of FIG. 2, the third capacitor 318 of FIG. 3 may correspond to the third capacitor 218 of FIG. 2, the drain-derived supply circuitry 332 may correspond to the drain-derived supply circuitry 232 of FIG. 2, etc. In some such examples, the hardware circuit element(s) and/or circuitry of FIG. 3 may have the same structure, electrical properties, and/or principle(s) of operation as the corresponding hardware circuit element(s) of FIG. 2.

An example controller 348 is part of the isolated switch circuitry 300 of FIG. 3. The controller 348 may achieve control and/or otherwise invoke operation of the third driver 324 and/or the fourth driver 326. In some examples, the controller 348 may be implemented by hardware logic, machine readable instructions, hardware implemented state machines, and/or any combination thereof. In some examples, the controller 348 may ground referenced employing level shifters to an example controller reference terminal 350 to transmit signals to the RX domain. For example, the controller reference terminal 350 may be grounded to the RX domain. In some examples, the controller 348 may be entirely within the RX domain and may not have the controller reference terminal 350.

In some examples, the isolation switch circuitry 300 of FIG. 3 is a single IC (such as a single IC package). For example, the first circuitry 302, the second circuitry 304, and the controller 348 may be part of the same die. In some examples, the isolation switch circuitry 300 may be implemented with two or more ICs (such as two or more IC packages.). For example, the first circuitry 302 may be on a first die, the second circuitry 304 may be on a second die, and the controller 348 may be on a third die. In some examples, the first circuitry 302 may be on a first die, the controller 348 may be on a second die, the drain-derived supply circuitry 232 may be on a third die, and the third driver 324, the fourth driver 326, and the first transistor 328 may be on a fourth die. Alternatively, any other combination maybe likewise appropriate (such as the controller 348 being part of the aforementioned first die, third die, or fourth die). Alternatively, one or more hardware circuit components (such as the first driver 306, the first capacitor 310, the diode bridge 316, etc.) of the first circuitry 302 may be included in the second circuitry 304. Alternatively, one or more hardware circuit components (such as the third driver 324, the first transistor 328, the drain-derived supply circuitry 332, etc.) of the second circuitry 304 may be included in the first circuitry 302. Alternatively, one or more hardware circuit components (such as the third diode 340, the second transistor 334, the resistor 338, etc.) of the drain-derived supply circuitry 332 may be included in the first circuitry 202.

A reference voltage (such as a reference voltage terminal) of the controller 348 is coupled to the diode bridge 316, a reference voltage of the third driver 324, a reference voltage of the fourth driver 326, a source of the first transistor 328, an anode of the fourth diode 342, and a gate of the third transistor 336. A first control output (such as a first control output terminal, a first controller output terminal, etc.) of the controller 348 is coupled to a control input of the third driver 324. A second control output (such as a second control output terminal, a second controller output terminal, etc.) of the controller 348 is coupled to a control input of the fourth driver 326.

In example operation, during a turn-on event (such as triggering the turn on of the first transistor 328), a self-induced common mode transient event may occur to cause V_{RX} to increase (such as become positive) and V_{DS} to decrease (such as decrease to zero). For example, the controller 348 may determine to turn on the third driver 324 and/or the fourth driver 326 based on a measurement (such as a current measurement, a voltage measurement, etc.). In some such examples, the controller 348 may receive a measurement indicative of V_{RX}, V_{DD(RX)}, V_{GS}, V_{DS}, V_{DRV}, and/or V_{AUX} and determine to turn on the third driver 324 and/or the fourth driver 326 based on the received measurement(s).

In example operation, the controller 348 may determine to turn on the third driver 324. For example, the controller 348 may output and/or otherwise generate a first control signal (such as V_{AUX_EN}) to be transmitted to the control input of the third driver 324 to cause the third driver 324 to turn on. In response to turning on the third driver 324, the third driver 324 outputs a second control signal (such as an output control signal) to turn on the switch 330 by closing the switch 330. In response to closing the switch 330, the drain-derived supply circuitry 332 provides charge (such as auxiliary charge) derived from a voltage at the drain of the first transistor 328. For example, the provided charge may flow in a direction represented by i_{DDS} in FIG. 3. The current i_{DDS} may charge the third capacitor 318 to provide additional charge to be supplied to the power inputs of the third driver 324 and/or the fourth driver 326.

In example operation, during the turn-on event, the controller 348 may determine to turn on the fourth driver 326. For example, the controller 348 may output and/or otherwise generate a third control signal (such as V_{DRV}) to be transmitted to the control input of the fourth driver 326 to cause the fourth driver 326 to turn on. In response to turning on the fourth driver 326, the fourth driver 326 outputs a fourth control signal (such as an output control signal) to turn on the first transistor 328 to cause the first transistor 328 to conduct current.

In example operation, in response to a collapse of V_{DS}, the self-induced common-mode transient may conclude. In example operation, in response to the conclusion of the self-induced common-mode transient, the drain-derived supply voltage V_{AUX} collapses. Advantageously, the controller 348 may cause the fourth driver 326 to have sufficient voltage at the power input of the fourth driver 326 to turn on and maintain the first transistor 328 in the on or enabled state during a self-induced common-mode transient event and, thereby, achieving power to continue to be delivered to the third capacitor 318.

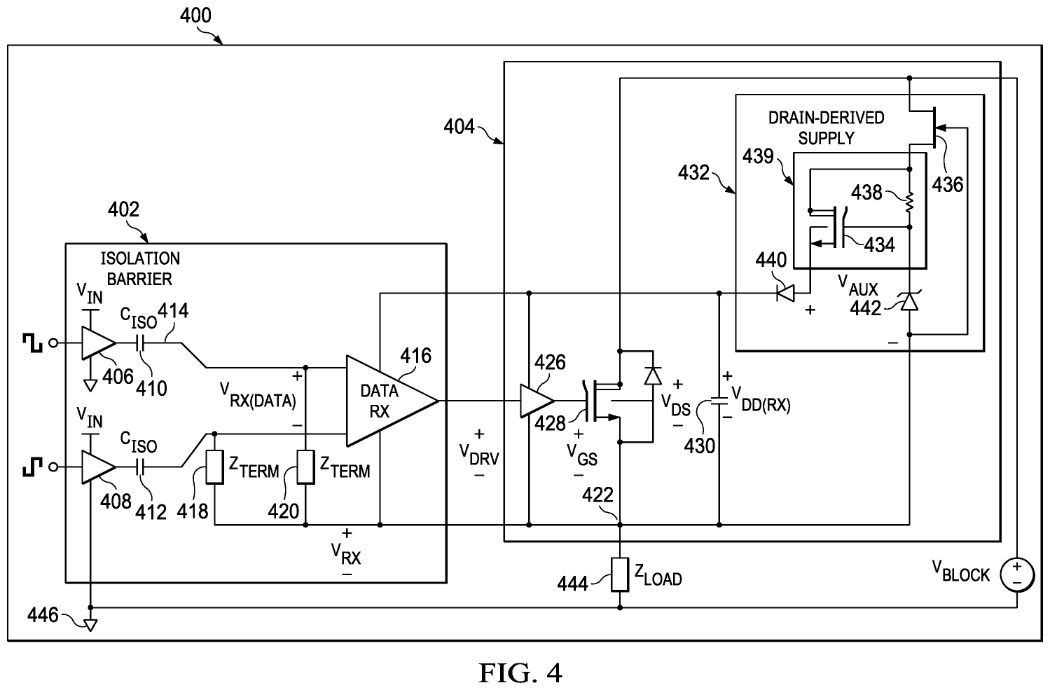

FIG. 4 is a schematic diagram of example isolated switch circuitry 400. The isolated switch circuitry 400 of FIG. 4 may be an example implementation of the isolated switch circuitry 100A-100F of FIG. 1. First example circuitry 402 and second example circuitry 404 are part of the isolated switch circuitry 400. A first example driver 406, a second example driver 408, a first example capacitor 410 and a second example capacitor 412 as part of an example isolation barrier 414, and example data receive (RX) circuitry 416 are part of the first circuitry 402. In this example, the isolated switch circuitry 400 may implement an isolated communication channel. For example, the data RX circuitry 416 may be implemented by a pre-amplifier (such as pre-amplifier circuitry), an envelope detector (such as envelope detector circuitry), and/or one or more filters (such as one or more filter logic circuits or circuitry). In some such examples, the data RX circuitry 416 may compare an envelope of a received signal at the inputs of the data RX circuitry 416 and compare the envelope to a known threshold. In some such examples, the data RX circuitry 416 may generate a first output (such as a logic high voltage indicative of a logic ‘1’) in response to the envelope exceeding and/or otherwise satisfying the known threshold. In some such examples, the data RX circuitry 416 may generate a second output (such as a logic low voltage indicative of a logic ‘0’) in response to the envelope falling below and/or otherwise not satisfying the known threshold.

A first example terminal impedance (Z_{TERM}) 418 is represented between a first input terminal of the data RX circuitry 416 and an example node 422. A second example terminal impedance (Z_{TERM}) 420 is represented between a second input terminal of the data RX circuitry 416 and the node 422. A voltage V_{RX(DATA)} is referenced between the input terminals of the data RX circuitry 416. A voltage V_{RX} is referenced between the node 422 and a reference voltage terminal 446.

A third example driver 426, a first example transistor 428, and a third example capacitor 430 are part of the second circuitry 404. A second example transistor 434, a third example transistor 436, an example resistor 438, a first example diode 440, and a second example diode 442 are part of the drain-derived supply circuitry 432. In this example, the resistor 438 and the second transistor 434 may be part of example source-follower circuitry 439. A drive voltage V_{DRV} may be provided to an input of the third driver 426. A gate-to-source voltage V_{GS} is across a gate and a source of the first transistor 428. A drain-to-source voltage V_{DS} is across a drain and the source of the first transistor 428. An auxiliary voltage V_{AUX} is at an anode of the first diode 440 with respect to the reference voltage terminal 446.

In the illustrated example of FIG. 4, one or more of the hardware circuit elements may correspond to one or more of the hardware circuit elements of FIGS. 2 and/or 3. For example, the first driver 406 of FIG. 4 may correspond to the first driver 206 of FIG. 2 and/or the first driver 306 of FIG. 3. In some examples, the third capacitor 430 of FIG. 4 may correspond to the third capacitor 218 of FIG. 2 and/or the third capacitor 318 of FIG. 3. In some examples, the drain-derived supply circuitry 432 of FIG. 4 may correspond to the drain-derived supply circuitry 232 of FIG. 2 and/or the drain-derived supply circuitry 332 of FIG. 3. In some such examples, the hardware circuit element(s) and/or circuitry of FIG. 4 may have the same structure, electrical properties, and/or principle(s) of operation as the corresponding hardware circuit element(s) of FIGS. 2 and/or 3.

An output of the first driver 406 is coupled to a first terminal of the first capacitor 410. A second terminal of the first capacitor 410 is coupled to the first input of the data RX circuitry 416. Power input(s) of the data RX circuitry 416 is/are coupled to a first terminal of the third capacitor 430 and a cathode of the first diode 440. Reference voltage(s) of the data RX circuitry 416 is/are coupled to source of the first transistor 428, the second terminal of the third capacitor 430, an anode of the second diode 442, and a gate of the third transistor 436. A control output of the data RX circuitry 416 is coupled to a control input of the third driver 426.

In example operation, the isolated switch circuitry 400 of FIG. 4 may implement an isolated communication channel. For example, the isolation barrier 414 of FIG. 4 may be used for the propagation of data signals rather than for power delivery. Advantageously, because the first capacitor 410 and the second capacitor 412 may be utilized for data delivery, the first capacitor 410 and the second capacitor 412 may be implemented with relatively small capacitors at lower cost with respect to capacitors utilized for power delivery. In example operation, a voltage supplied to the power input of the data RX circuitry 416 is derived and/or otherwise based on a drain voltage of the first transistor 428. In example operation, in response to turning on the first transistor 428, V_{DS} collapses, but the negative feedback loop of the drain-derived supply circuitry 432, the supplied charge from the drain-derived supply circuitry 432 stops and/or otherwise slows a rate of voltage collapse. For example, V_{AUX} may remain relatively steady in response to V_{DS} collapsing. In some examples, V_{DS} is regulated to a voltage in a range of 2-3 V. Advantageously, the drain-derived supply circuitry 432 of FIG. 4 may provide additional charge derived from the drain of the first transistor 428 to implement an isolated communication channel for data receipt and/or transmission.

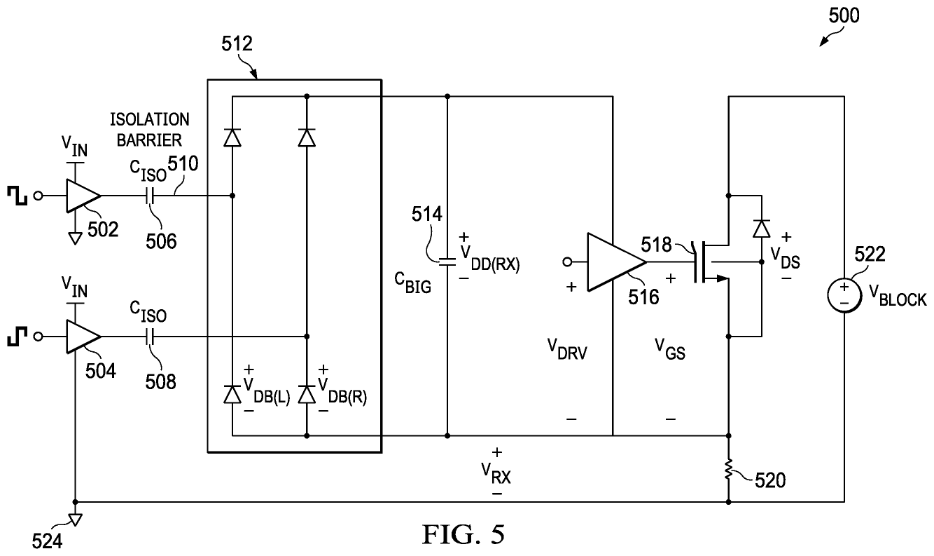

FIG. 5 is a schematic diagram of example isolated switch circuitry 500. The isolated switch circuitry 500 of FIG. 5 may be an example implementation of the isolated switch circuitry 100A-100F of FIG. 1. A first example driver 502, a second example driver 504, a first example capacitor 506 and a second example capacitor 508 part of an example isolation barrier 510, an example diode bridge 512, a third example capacitor 514, a third example driver 516, an example transistor 518, and an example resistor 520 are part of the isolated switch circuitry 500. The third capacitor 514 has a capacitance of C_{BIG} and has a voltage V_{DD(RX)}. A drive voltage V_{DRV} may be supplied to a control input of the third driver 516. A gate-to-source voltage V_{GS} is across a gate and a source of the transistor 518. A drain-to-source voltage V_{DS} is across a drain and the source of the transistor 518. The isolated switch circuitry 500 may implement an example blocking voltage V_{BLOCK} 522 across the drain and an example reference voltage terminal 524. In this example, the transistor 518 is an N-channel MOSFET.

The isolated switch circuitry 500 of FIG. 5 may implement a capacitively powered and isolated driver system. In this example, when the transistor 518 is turned off, V_{RX} is approximately zero (such as at an equipotential voltage). When the transistor 518 is turned on, V_{RX} may increase to V_{BLOCK}. The first capacitor 506 and the second capacitor 508 may charge with common-mode current to support the ground difference. In this example, if the common-mode current is greater than the differential-mode current, then V_{DD(RX)} may drop below a threshold voltage needed to sufficiently power the third driver 516. In response to the third driver 516 not having sufficient power (such as experiencing a current drought from the drop in V_{DD(RX)}), the third driver 516 may not turn on the transistor 518 as needed. In this example, the third capacitor 514 has a capacitance that is substantially large (C_{BIG}) to mitigate the drop in V_{DD(RX)} that may cause the current drought of the third driver 516.

Advantageously, the drain-derived supply circuitry 232, 332, 432 of FIGS. 2, 3, and/or 4 is/are improvement(s) over the isolated switch circuitry 500 of FIG. 5. For example, the drain-derived supply circuitry 232, 332, 432 of FIGS. 2, 3, and/or 4 may supply additional charge based on the drain voltage of the transistor 518 to maintain V_{DD(RX)} at or above a threshold voltage (such as an adequate voltage to power the third driver 516 to turn on the transistor 518 when instructed). Advantageously, the drain-derived supply circuitry 232, 332, 432 of FIGS. 2, 3, and/or 4 may enable the third capacitor 514 to have a substantially lower capacitance with respect to the third capacitor 218, 318, 430 of FIGS. 2, 3, and/or 4.

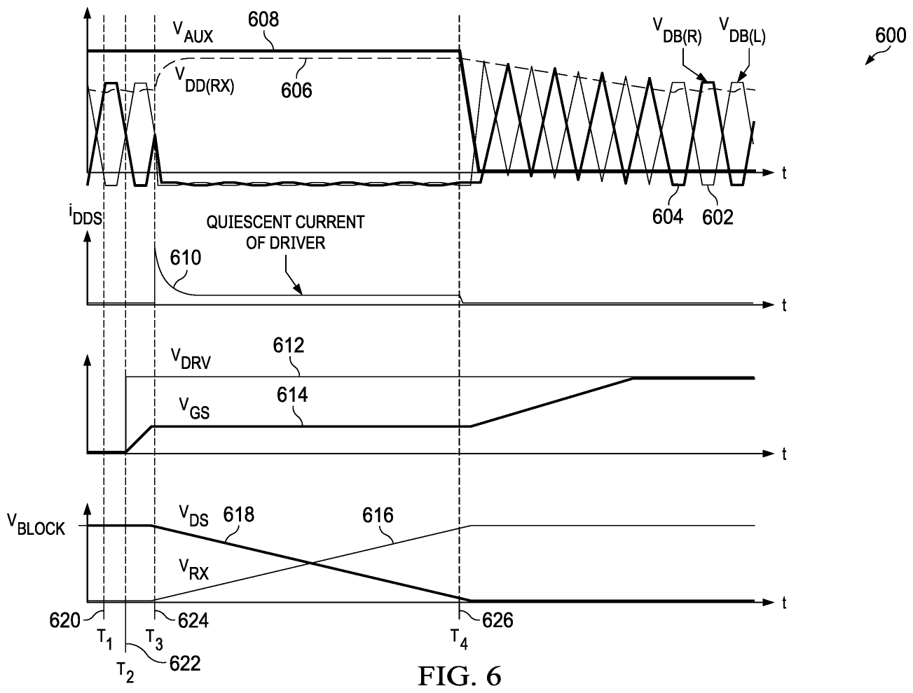

FIG. 6 depicts an example timing diagram 600 corresponding to example operation of the isolated switch circuitry 100A-100F of FIG. 1, the isolated switch circuitry 200 of FIG. 2, and/or the isolated switch circuitry 300 of FIG. 3. A first example waveform 602, a second example waveform 604, a third example waveform 606, a fourth example waveform 608, a fifth example waveform 610, a sixth example waveform 612, a seventh example waveform 614, an eighth example waveform 616, and a ninth example waveform 618 are part of the timing diagram 600.

The first waveform 602 may correspond to a voltage V_{DB(L)} across the first diode 220 of FIG. 2 and/or the first diode 320 of FIG. 3. The second waveform 604 may correspond to a voltage V_{DB(R)} across the second diode 222 of FIG. 2 and/or the second diode 322 of FIG. 3. The third waveform 606 may correspond to a voltage V_{DD(RX)} across the third capacitor 218 of FIG. 2 and/or the third capacitor 318 of FIG. 3. The fourth waveform 608 may correspond to a voltage V_{AUX} supplied by the drain-derived supply circuitry 232 of FIG. 2 and/or the drain-derived supply circuitry 332 of FIG. 3. The fifth waveform 610 may correspond to a current i_{DDS} that may flow through the switch 230 of FIG. 2 and/or the switch 330 of FIG. 3. The sixth waveform 612 may correspond to a voltage V_{DRV} that may be provided to the control input of the fourth driver 226 of FIG. 2 and/or the fourth driver 326 of FIG. 3. The seventh waveform 614 may correspond to a gate-to-source voltage V_{GS} of the first transistor 228 of FIG. 2 and/or the first transistor 328 of FIG. 3. The eighth waveform 616 may correspond to a drain-to-source voltage V_{DS} of the first transistor 228 of FIG. 2 and/or the first transistor 328 of FIG. 3. The ninth waveform 618 may correspond to the voltage V_{RX} of FIGS. 2 and/or 3.

In the example timing diagram 600 of FIG. 6, at a first example time T₁ 620, V_{DRV} is at a first voltage level (such as a logic low voltage indicative of a logic ‘0’), V_{GS} is at a first voltage level indicative of the first transistor 228 being turned off, the switch 230 is open, and V_{DS} is at V_{BLOCK}. At the first time 620, V_{DB(L)} is at a first voltage level indicative of a negative voltage sent by the first driver 206. At the first time 620, V_{DB(R)} is at a second voltage level, which is greater than the first voltage level, indicative of a positive voltage being sent by the second driver 208.

At a second example time T₂ 622, the fourth driver 226 is instructed to be turned on in response to V_{DRV} rising from the first voltage level to a second voltage level (such as a logic high voltage indicative of a logic ‘1’). For example, the second time 622 may correspond to a turn-on event of the first transistor 228. In some such examples, the fourth driver 226 may initialize turning on of the first transistor 228. At the second time 622, V_{DB(L)} is at a third voltage level greater than the first voltage level but less than the second voltage level, which is indicative of an increase of the voltage sent by the first driver 206 at the first time 620. At the second time 622, V_{DB(R)} is at the third voltage level, which is indicative of a decrease of the voltage sent by the second driver 208 at the first time 620.

At a third example time T₃ 624, the first transistor 228 is on based on V_{GS} rising from a first voltage level to a second voltage level. At the third time 624, the third driver 224 turns on the switch 230. At the third time 624, in response to turning on the switch 230, i_{DDS} increases, which is indicative of charge being output from the drain-derived supply circuitry 232. Advantageously, i_{DDS} is based on and/or otherwise derived from V_{DS} of the first transistor 228. In response to i_{DDS} flowing through the switch 230, the third capacitor 218 is charging, which causes V_{DD(RX)} to increase. Advantageously, at the third time 624, V_{RX} is beginning to increase, which is indicative of the common-mode current not overwhelming and/or otherwise exceeding the differential-mode current of the isolation switch circuitry 200 of FIG. 2 and/or the isolation switch circuitry 300 of FIG. 3.

In this example, a common-mode transient event spans the third time 624 until a fourth example time T₄ 626. At the fourth time 626, V_{DS} has collapsed, which concludes the common-mode transient event and causes the drain-derived supply voltage V_{AUX} to collapse. In response to the collapse of V_{DS}, i_{DDS} also collapses. After the fourth time 720, power continues to flow to through the diode bridge 216 of FIG. 2 and/or the diode bridge 316 of FIG. 3. Advantageously, the drain-derived supply circuitry 232 of FIG. 2 and/or the drain-derived supply circuitry 332 of FIG. 3 may provide V_{AUX} during the common-mode transient event to ensure proper operation of the fourth driver 226 of FIG. 2 and/or the fourth driver 326 of FIG.

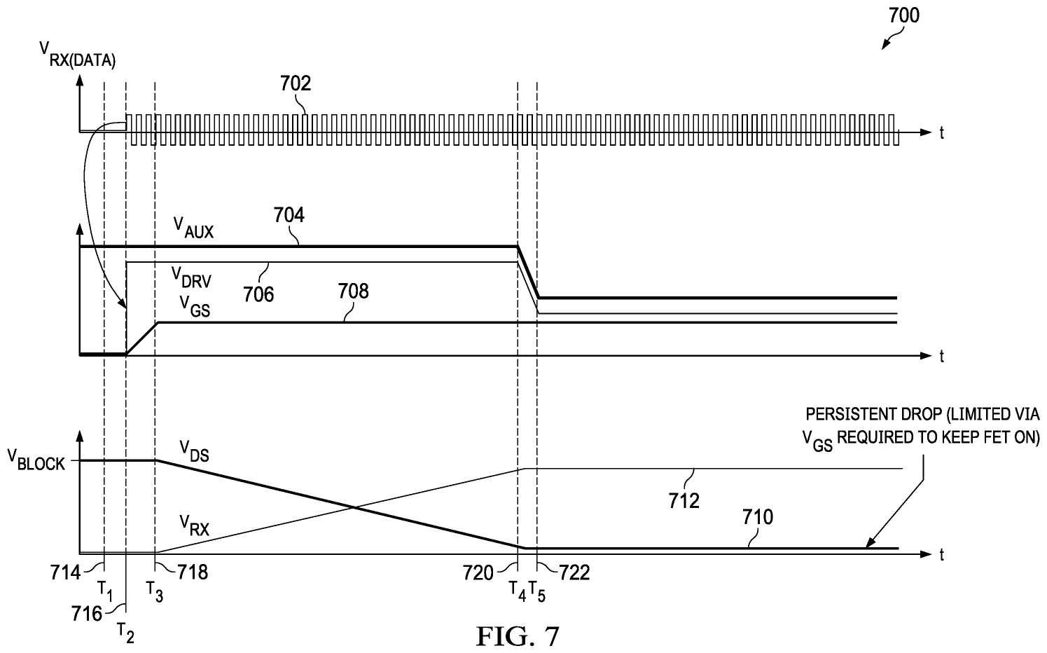

FIG. 7 depicts an example timing diagram corresponding to example operation of the isolated switch circuitry 100A-100F of FIG. 1 and/or the isolated switch circuitry 400 of FIG. 4. A first example waveform 702, a second example waveform 704, a third example waveform 706, a fourth example waveform 708, a fifth example waveform 710, and a sixth example waveform 712 are part of the timing diagram 700.

The first waveform 702 may correspond to a voltage V_{RX(DATA)} at the inputs of the data RX circuitry 416 of FIG. 4. The second waveform 704 may correspond to a voltage V_{AUX} supplied by the drain-derived supply circuitry 432 of FIG. 4. The third waveform 706 may correspond to a voltage V_{DRV} that may be provided to the control input of the third driver 426 of FIG. 4. The fourth waveform 708 may correspond to a gate-to-source voltage V_{GS} of the first transistor 428 of FIG. 4. The fifth waveform 710 may correspond to a drain-to-source voltage V_{DS} of the first transistor 428 of FIG. 4. The sixth waveform 712 may correspond to the voltage V_{RX} of FIG. 4.

In the example timing diagram 700 of FIG. 7, at a first example time T₁ 714, V_{DRV} is at a first voltage level (such as a logic low voltage indicative of a logic ‘0’), V_{GS} is at a first voltage level indicative of the first transistor 428 being turned off, V_{DS} is at V_{BLOCK}, and the isolated switch circuitry 400 of FIG. 4 is not switching at a carrier frequency based on V_{RX(DATA)} not having a voltage. In this example, V_{AUX} is at a first voltage level based on V_{DS} being at V_{BLOCK}.

In this example, the data RX circuitry 416, and/or, more generally, the isolated switch circuitry 400 of FIG. 4, may implement an on-off keying communication protocol to improve data robustness. For example, the data RX circuitry 416 may output a logic ‘1’ in response to a switch event (such as V_{RX(DATA)} being toggled from a high voltage to a low voltage or from a low voltage to a high voltage) at a carrier frequency (such as a desired or specified carrier frequency or a carrier frequency of interest). In some such examples, the data RX circuitry 416 may output a logic ‘0’ in response to a non-switch event (such as V_{RX(DATA)} not being toggled).

At a second example time T₂ 716, the data RX circuitry 416 of FIG. 4 outputs a logic ‘1’ based on a switching of V_{RX(DATA)}. At the second time 716, in response to the output of the logic ‘1’, the third driver 426 is instructed to be turned on. For example, the third driver 426 may be turned on in response to V_{DRV} rising from the first voltage level to a second voltage level (such as a logic high voltage indicative of a logic ‘1’). For example, the second time 716 may correspond to a turn-on event of the first transistor 428. In some such examples, the third driver 426 may initialize a turn on of the first transistor 428.

At a third example time T₃ 718, the first transistor 428 is on in response to V_{GS} rising from a first voltage level to a second voltage level. In this example, the drain-derived supply circuitry 432 provides charge (such as charge based on V_{AUX}) based on V_{DS} to the third capacitor 430 of FIG. 4.

In this example, a common-mode transient event spans the third time 718 until a fourth example time T₄ 720. At the fourth time 720, V_{DS} has collapsed, which concludes the common-mode transient event and causes the drain-derived supply voltage V_{AUX} to decrease. In this example, V_{DS} does not completely collapse due to the V_{GS} utilized to keep the first transistor 428 on. Because there the drain-derived supply circuitry 432 may implement a negative feedback loop, V_{AUX} stops decreasing at a fifth example time T₅ 722. After the fourth time 720, the first transistor 228 is fully turned on based on V_{GS} increasing to V_{DRV} After the fourth time 626, data continues to flow through the capacitive channel via the first circuitry 402 of FIG. 4. Advantageously, the drain-derived supply circuitry 432 provides V_{AUX} during the common-mode transient event to ensure proper operation of the third driver 426 of FIG. 4.

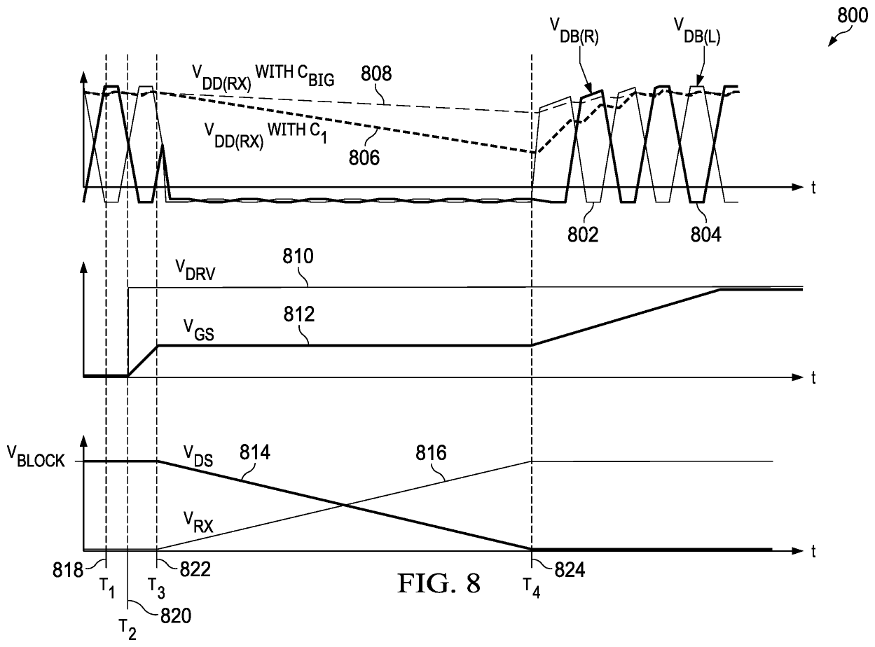

FIG. 8 depicts an example timing diagram 800 corresponding to example operation of the isolated switch circuitry 500 of FIG. 5. A first example waveform 802, a second example waveform 804, a third example waveform 806, a fourth example waveform 808, a fifth example waveform 810, a sixth example waveform 812, a seventh example waveform 814, and an eighth example waveform 816 are part of the timing diagram 800.

The first waveform 802 may correspond to V_{DB(L)} of FIG. 5. The second waveform 804 may correspond to V_{DB(R)} of FIG. 5. The third waveform 806 may correspond to a voltage V_{DD(RX)} across the third capacitor 514 of FIG. 5 based on the third capacitor 514 having a first capacitance. The fourth waveform 808 may correspond to the voltage V_{DD(RX)} across the third capacitor 514 of FIG. 5 based on the third capacitor 514 having capacitance C_{BIG}. In this example, C_{BIG} is greater (such as substantially greater) than Ci. The fifth waveform 810 may correspond to a voltage V_{DRV} that may be provided to the control input of the third driver 516 of FIG. 5. The sixth waveform 812 may correspond to a gate-to-source voltage V_{GS} of the transistor 518 of FIG. 5. The seventh waveform 814 may correspond to a drain-to-source voltage V_{DS} of the transistor 518 of FIG. 5. The eighth waveform 816 may correspond to the voltage V_{RX} of FIG. 5.

In the example timing diagram 800 of FIG. 8, at a first example time T₁ 818, V_{DRV} is at a first voltage level (such as a logic low voltage indicative of a logic ‘0’), V_{GS} is at a first voltage level indicative of the transistor 518 being turned off, and V_{DS} is at V_{BLOCK}. At the first time 818, V_{DB(L)} is at a first voltage level indicative of a negative voltage sent by the first driver 502 of FIG. 5. At the first time 818, V_{DB(R)} is at a second voltage level, which is greater than the first voltage level, indicative of a positive voltage being sent by the second driver 504 of FIG. 5.

At a second example time T₂ 820, the third driver 516 is instructed to be turned on in response to V_{DRV} rising from the first voltage level to a second voltage level (such as a logic high voltage indicative of a logic ‘1’). For example, the second time 820 may correspond to a turn-on event of the transistor 518. In some such examples, the third driver 516 may initialize turning on of the transistor 518. At the second time 820, V_{DB(L)} is at a third voltage level greater than the first voltage level but less than the second voltage level, which is indicative of an increase of the voltage sent by the first driver 502 at the first time 818. At the second time 820, V_{DB(R)} is at the third voltage level, which is indicative of a decrease of the voltage sent by the second driver 504 at the first time 818.

At a third example time T₃ 822, the transistor 518 is on based on V_{GS} rising from a first voltage level to a second voltage level. At the third time 822, the third waveform 806 and the fourth waveform 808 begin to diverge based on the capacitance of the third capacitor 514. In this example, as V_{RX} increases, V_{DD(RX)} decreases because of the absence of the auxiliary charge provided by the drain-derived supply circuitry 232 of FIG. 2, the drain-derived supply circuitry 332 of FIG. 3, and/or the drain-derived supply circuitry 332 of FIG. 4. In this example, V_{DD(RX)} decreases at a greater rate with respect to decreased capacitance of the third capacitor 514. In some examples, increasing the capacitance of the third capacitor 514 may mitigate a common-mode transient by reducing the rate of decrease of V_{DD(RX)}, but increasing the capacitance increases the physical size of the third capacitor 514 and thereby consumes an increased area of physical space on an IC.

In this example, a common-mode transient event spans the third time 822 until a fourth example time T₄ 824. At the fourth time 824, V_{DS} has collapsed, which concludes the common-mode transient event and causes V_{DD(RX)} to increase. After the fourth time 824, power continues to flow through the capacitive channel of the isolation switch circuitry 500 of FIG. 5. Advantageously, the drain-derived supply circuitry 232 of FIG. 2, the drain-derived supply circuitry 332 of FIG. 3, and/or the drain-derived supply circuitry 432 of FIG. 4 increases V_{DD(RX)} (as illustrated in the example timing diagram 600 of FIG. 6) during the common-mode transient event in contrast to the decrease in V_{DD(RX)} from the third time 822 to the fourth time 824 depicted in the example timing diagram 800 of FIG. 8.

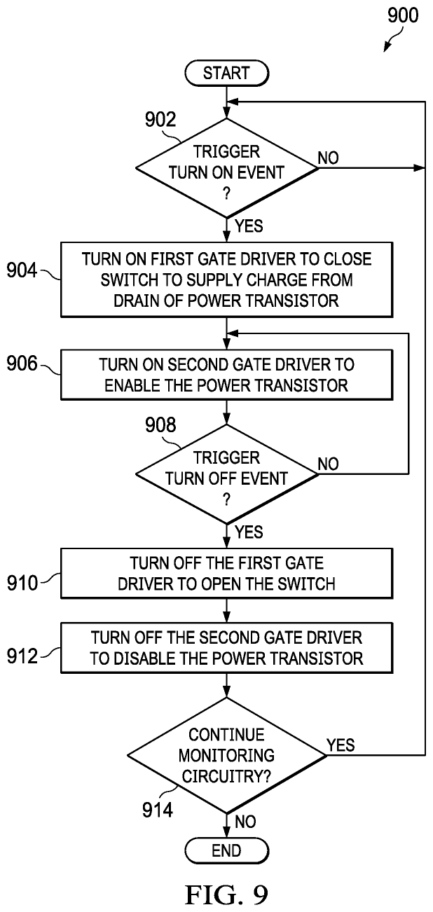

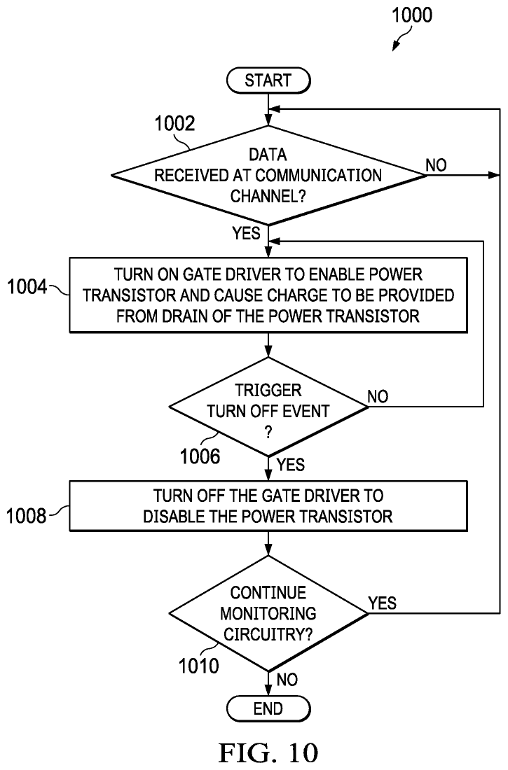

Flowcharts representative of an example process that may be performed using example hardware logic, example machine readable instructions (such as hardware readable instructions), example hardware implemented state machines, and/or any combination thereof configured to implement the example isolation switch circuitry 100A-100F of FIG. 1, the example isolation switch circuitry 200 of FIG. 2, the example isolation switch circuitry 300 of FIG. 3, the example controller 348 of FIG. 3, and/or the example isolation switch circuitry 400 of FIG. 4 are shown in FIGS. 9-10. The example machine readable instructions may be one or more executable programs or portion(s) of an executable program for execution by programmable processor(s) (such as programmable microprocessor(s)), programmable controller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) (such as field programmable gate array(s) (FGPA(s)). The program may be embodied in software stored on a non-transitory computer readable storage medium (such as a non-volatile memory, volatile memory, etc.), but the entire program and/or parts thereof could alternatively be executed by any other device (such as a programmable device) and/or embodied in firmware or dedicated hardware. Further, although the example program(s) is/are described with reference to the flowcharts illustrated in FIGS. 9-10, many other methods of implementing the example isolation switch circuitry 100A-100F of FIG. 1, the example isolation switch circuitry 200 of FIG. 2, the example isolation switch circuitry 300 of FIG. 3, the example controller 348 of FIG. 3, and/or the example isolation switch circuitry 400 of FIG. 4 may alternatively be used. For example, the order of execution of the blocks may be changed, and/or some of the blocks described may be changed, eliminated, or combined. Additionally or alternatively, any or all of the blocks may be implemented by one or more hardware circuits (such as discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (such as portions of instructions, code, representations of code, etc.) useful to create, manufacture, and/or produce machine executable instructions. For example, the machine readable instructions may be fragmented and stored on one or more storage devices. The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

The machine readable instructions described herein can be represented by any past, present, or future instruction language, scripting language, programming language, etc. For example, the machine readable instructions may be represented using any of the following languages: assembly language, C, C++, Java, C#, Perl, Python, JavaScript, HyperText Markup Language (HTML), Structured Query Language (SQL), Swift, etc.

As described above, the example processes of FIGS. 9-10 may be implemented using executable instructions (such as computer, machine, and/or hardware readable instructions) stored on a non-transitory computer and/or machine readable medium, such as a flash memory, a read-only memory, a cache, a random-access memory, and/or any other storage device or storage disk in which information is stored for any duration (such as for extended time periods, permanently, for brief instances, for temporarily buffering, and/or for caching of the information). As used herein, the terms non-transitory computer readable medium, non-transitory machine readable medium, and/or non-transitory hardware readable medium is/are expressly defined to include any type of computer, machine, and/or hardware readable storage device and/or storage disk and to exclude propagating signals and to exclude transmission media.

FIG. 9 is a flowchart representative of an example process 900 that may be performed using machine readable instructions that can be executed and/or hardware configured to implement the example isolation switch circuitry 100A-100F of FIG. 1, the example isolation switch circuitry 200 of FIG. 2, the example isolation switch circuitry 300 of FIG. 3, and/or the example controller 348 of FIG. 3 to achieve isolated gate control. The process 900 of FIG. 9 begins at block 902, at which logic circuitry determines whether to trigger a turn on event. For example, the controller 348 may determine whether to turn on the first transistor 328 of FIG. 3.

If, at block 902, the logic circuitry determines not to trigger the turn on event, the logic circuitry waits until the turn on event is determined to be triggered. If, at block 902, the logic circuitry determines to trigger the turn on event, then, at block 904, the logic circuitry turns on a first gate driver to close a switch to supply charge from drain of a power transistor. For example, the controller 348 may output a first control signal (such as V_{AUX_EN} of FIG. 3) to the third driver 324 to turn on the third driver 324. In some such examples, in response to turning on the third driver 324, the third driver 324 closes the switch 330 of FIG. 3. In some such examples, in response to closing the switch 330, the drain-derived supply circuitry 332 provides charge (such as i_{DDS} of FIG. 3) to the third capacitor 318 of FIG. 3.

At block 906, the logic circuitry turns on a second gate driver to enable the power transistor. For example, the controller 348 may output a second control signal (such as V_{DRV} of FIG. 3) to the fourth driver 326 to turn on the first transistor 328 of FIG. 3.

At block 908, the logic circuitry determines whether to trigger a turn off event. For example, the controller 348 may determine whether to turn of the first transistor 328 of FIG. 3. If, at block 908, the logic circuitry determines not to trigger the turn off event, the logic circuitry continues to turn on the second gate driver to enable the power transistor. If, at block 908, the logic circuitry determines to trigger the turn off event, then, at block 910, the logic circuitry turns off the first gate driver to open the switch. For example, the controller 348 may output a third control signal to the third driver 324 to turn off the third driver 324. In some such examples, in response to turning off the third driver 324, the third driver 324 may open the switch 330 of FIG. 3. In some such examples, in response to opening the switch 330, the drain-derived supply circuitry 332 may cease providing charge (such as i_{DDS} of FIG. 3) to the third capacitor 318 of FIG. 3.

At block 912, the logic circuitry turns off the second gate driver to disable the power transistor. For example, the controller 348 may output a fourth control signal to the fourth driver 326 to turn off the first transistor 328 of FIG. 3.

At block 914, the logic circuitry determines whether to continue monitoring the circuitry. For example, the controller 348 may determine whether to continue monitoring the isolated switch circuitry 300 of FIG. 3 (or portion(s) thereof). If, at block 914, the logic circuitry determines to continue monitoring the circuitry, the logic circuitry returns to block 902 to determine whether to trigger a turn on event, otherwise the example process 900 of FIG. 9 concludes.

FIG. 10 is a flowchart representative of an example process 1000 that may be performed using machine readable instructions that can be executed and/or hardware configured to implement the example isolation switch circuitry 100A-100F of FIG. 1 and/or the example isolation switch circuitry 400 of FIG. 4 to achieve isolated gate control. The example process 1000 of FIG. 10 begins at block 1002, at which logic circuitry determines whether data has been received at a communication channel. For example, the data RX circuitry 416 of FIG. 4 may determine that data has been received at the inputs of the data RX circuitry 416 based on the first waveform 702 of FIG. 7.

If, at block 1002, the logic circuitry determines that data has not been received at the communication channel, the logic circuitry waits at block 1002 until the data is determined to have been received. If, at block 1002, the logic circuitry determines that data has been received at the communication channel, then, at block 1002, the logic circuitry turns on a gate driver to enable a power transistor and cause charge to be provided from a drain of the power transistor. For example, the data RX circuitry 416 may output a control signal to turn on the third driver 426 of FIG. 4. In some such examples, in response to turning on the third driver 426, the third driver 426 may turn on the first transistor 428. In some such examples, the drain-derived supply circuitry 432 may provide charge from the drain of the first transistor 428 to the third capacitor 430 of FIG. 4.

At block 1006, the logic circuitry determines whether to trigger a turn off event. For example, the data RX circuitry 416 may determine that data is no longer being received at the inputs of the data RX circuitry 416. In some such examples, the data RX circuitry 416 may determine to trigger a turn off event based on the determination that data is not being received.

If, at block 1006, the logic circuitry determines not to trigger the turn off event, the logic circuitry returns to block 1004 to continue turning on the gate driver to enable the power transistor and cause the charge to be provided from the drain of the power transistor. If, at block 1006, the logic circuitry determines to trigger the turn off event, then, at block 1008, the logic circuitry turns off the gate driver to disable the power transistor. For example, the data RX circuitry 416 may output a control signal to turn off the third driver 426.

At block 1010, the logic circuitry determines whether to continue monitoring circuitry. For example, the data RX circuitry 416 may determine whether to continue monitoring the isolated switch circuitry 400 of FIG. 4 (or portion(s) thereof). If, at block 1010, the logic circuitry determines to continue monitoring the circuitry, the logic circuitry returns to block 1002 to determine whether data has been received at the communication channel, otherwise the example process 1000 of FIG. 10 concludes.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

Example methods, apparatus, and articles of manufacture described herein improve control of driver circuitry (such as driver circuitry part of isolated switch circuitry). Advantageously, methods, apparatus, and articles of manufacture described herein eliminate and/or otherwise reduce current droughts in driver circuitry by providing auxiliary charge derived from drain-assisted supply circuitry. Advantageously, methods, apparatus, and articles of manufacture described herein may provide such auxiliary charge in response to engaging and/or otherwise enabling a power transistor. Advantageously, methods, apparatus, and articles of manufacture described herein achieve a reduction in size of decoupling capacitor(s) part of the driver circuitry. Advantageously, methods, apparatus, and articles of manufacture described herein support a wide range of self-induced common-mode transient rates.

Modifications are possible in the described embodiments, and other embodiments are possible, within the scope of the claims.

What is claimed is:

1. An apparatus comprising:
a gate driver with a control output terminal;
a power transistor with a gate terminal and a first current terminal, the gate terminal coupled to the control output terminal; and
drain-derived supply circuitry with an output coupled to the first current terminal.

2. The apparatus of claim 1, wherein the gate driver is a first gate driver, the first gate driver has a first power input terminal, the output is a first output, the drain-derived supply circuitry has a second output, and the apparatus further comprising:
a switch with a first switch terminal, a second switch terminal, and a switch control terminal, the first switch terminal coupled to the first power input terminal, the second switch terminal coupled to the second output; and
a second gate driver with a second power input terminal and a second control output terminal, the second power input terminal coupled to the first switch terminal, the second control output terminal coupled to the switch control terminal.

3. The apparatus of claim 1, wherein the first current terminal is a drain terminal, and the drain-derived supply circuitry includes a first transistor with a second current terminal coupled to the drain terminal of the power transistor.

4. The apparatus of claim 3, wherein the first transistor has a third current terminal, and the drain-derived supply circuitry includes:
a resistor with a first resistor terminal and a second resistor terminal, the first resistor terminal coupled to the third current terminal; and
a second transistor with a fourth current terminal and a gate terminal, the fourth current terminal coupled to the first resistor terminal and the third current terminal, the gate terminal coupled to the second resistor terminal.

5. The apparatus of claim 4, wherein the first transistor is a N-channel junction field-effect transistor, and the second transistor is a N-channel metal-oxide semiconductor field-effect transistor.

6. The apparatus of claim 4, wherein the second transistor has a fifth current terminal, the power transistor has a sixth current terminal, and the drain-derived supply circuitry includes:
a first diode with a first anode coupled to the fifth current terminal; and
a second diode with a second anode and a first cathode, the second anode coupled to the sixth current terminal, the first cathode coupled to the gate terminal and the second resistor terminal.

7. The apparatus of claim 1, wherein the drain-derived supply circuitry includes a first transistor with a second current terminal, and the apparatus further comprising a switch with a first switch terminal coupled to the second current terminal.

8. The apparatus of claim 7, wherein the drain-derived supply circuitry includes a diode with an anode and a cathode, the anode is coupled to the second current terminal, the cathode is coupled to the first switch terminal.

9. The apparatus of claim 8, wherein the gate driver is a first gate driver, the first gate driver has a first power input terminal, the output is a first output, the drain-derived supply circuitry has a second output, the switch has a second switch terminal and a switch control terminal, and the apparatus further comprising:
a second gate driver with a second power input terminal and a second control output terminal, the second power input terminal coupled to the second switch terminal, the second control output terminal coupled to the switch control terminal.

10. The apparatus of claim 9, wherein the first power input terminal is coupled to the second current terminal through the switch.

11. The apparatus of claim 9, wherein the second gate driver has a control input terminal, and the apparatus further comprising a controller with a controller output terminal coupled the control input terminal.

12. The apparatus of claim 11, wherein the controller output terminal is a first controller output terminal, the controller has a second controller output terminal, the first gate driver has a first control input terminal coupled to the second controller output terminal.

13. The apparatus of claim 1, wherein the power transistor is a N-channel metal-oxide semiconductor field-effect transistor.

14. An apparatus comprising:
a first transistor with a first current terminal and a second current terminal;
a second transistor with a third current terminal and a fourth current terminal, the third current terminal coupled to the first current terminal;
a diode with a first diode terminal and a second diode terminal, the first diode terminal coupled to the fourth current terminal; and
source-follower circuitry coupled to the second diode terminal.

15. The apparatus of claim 14, wherein the source-follower circuitry includes:
a resistor with a first resistor terminal and a second resistor terminal; and
a third transistor with a third current terminal and a gate terminal, the third current terminal coupled to the second current terminal and the first resistor terminal, the gate terminal coupled to the second resistor terminal and the second diode terminal.

16. The apparatus of claim 14, wherein the first transistor includes a gate terminal, the diode is a first diode, and the apparatus further comprising:
a second diode; and
a capacitor with a first capacitor terminal and a second capacitor terminal, the first capacitor terminal coupled to the source-follower circuitry through the second diode, the second capacitor terminal coupled to the first diode terminal and the gate terminal.

17. The apparatus of claim 14, wherein the diode is a first diode, the second transistor with a gate terminal, and the apparatus further comprising:
a second diode; and
a gate driver with a power input terminal and a control output terminal, the power input terminal coupled to the source-follower circuitry through the second diode, the control output terminal coupled to the gate terminal.

18. A system comprising:
relay circuitry;
driver circuitry coupled to the relay circuitry and a battery charging terminal, the driver circuitry adapted to be coupled to a battery; and
switch circuitry coupled to the driver circuitry, the switch circuitry adapted to be coupled to the battery, the switch circuitry including:
a first transistor with a first current terminal and a second current terminal, the first current terminal coupled to a third current terminal of a second transistor;
a diode with a first diode terminal and a second diode terminal, the first diode terminal coupled to a fourth current terminal of the second transistor; and
source-follower circuitry coupled to the second diode terminal.

19. The system of claim 18, wherein the source-follower circuitry includes:
a resistor with a first resistor terminal and a second resistor terminal; and
a third transistor with a fifth current terminal and a gate terminal, the fifth current terminal coupled to the second current terminal and the first resistor terminal, the gate terminal coupled to the second resistor terminal and the second diode terminal.

20. The system of claim 18, wherein the switch circuitry is adapted to be coupled to a control unit of an electric vehicle, and the battery is adapted to output power to the electric vehicle.

21. A battery electric vehicle system comprising:
one or more batteries;
a battery charging terminal;
relay circuitry coupled to the battery charging terminal;
driver circuitry coupled to the relay circuitry and the one or more batteries; and
switch circuitry coupled to the driver circuitry and the one or more batteries, the switch circuitry including:
a gate driver with a control output terminal;
a power transistor with a gate terminal and a first current terminal, the gate terminal coupled to the control output terminal; and
drain-derived supply circuitry with an output coupled to the first current terminal.

22. The battery electric vehicle system of claim 21, further comprising:
a first sensor coupled to the switch circuitry and the one or more batteries;
a second sensor coupled to the relay circuitry; and
a third sensor coupled to the battery charging terminal.

23. The battery electric vehicle system of claim 21, further comprising a control unit with a first control unit output coupled to the switch circuitry.

24. The battery electric vehicle system of claim 21, wherein the gate driver is a first gate driver, the first gate driver has a first power input terminal, the output is a first output, the drain-derived supply circuitry has a second output, and the switch circuitry includes:
a switch with a first switch terminal, a second switch terminal, and a switch control terminal, the first switch terminal coupled to the first power input terminal, the second switch terminal coupled to the second output; and
a second gate driver with a second power input terminal and a second control output terminal, the second power input terminal coupled to the first switch terminal, the second control output terminal coupled to the switch control terminal.

25. The battery electric vehicle system of claim 21, wherein the first current terminal is a drain terminal, and the drain-derived supply circuitry includes:
a first transistor with a second current terminal and a third current terminal, the second current terminal coupled to the drain terminal of the power transistor;
a resistor with a first resistor terminal and a second resistor terminal, the first resistor terminal coupled to the third current terminal; and
a second transistor with a fourth current terminal and a gate terminal, the fourth current terminal coupled to the first resistor terminal and the third current terminal, the gate terminal coupled to the second resistor terminal.
